(19) United States
(12) Patent Application Publication
(10) Pub. No.: US 2015/0302342 A1
(43) Pub. Date: Oct. 22, 2015

(54) TAXI MANAGEMENT APPARATUS AND TAXI MANAGEMENT SYSTEM

(71) Applicant: Wei-Yen Yeh, Taipei (TW)

(72) Inventor: Wei-Yen Yeh, Taipei (TW)

(21) Appl. No.: 14/332,725

(22) Filed: Jul. 16, 2014

(30) Foreign Application Priority Data
Apr. 21, 2014 (TW) 103114350

(51) Int. Cl. G06Q 10/06; G07B 13/00

(52) U.S. Cl. CPC G06Q 10/063114; G07B 13/00

(57) ABSTRACT

Provided is a taxi management apparatus, including a taximeter that is installed in a taxi and a driver-side device that is electrically connected to the taximeter. The taximeter generates real-time positioning data and charging data of the taxi. The driver-side device generates dynamic data of a geographic region where the taxi is located and passenger information. A taxi management system is also provided that includes a management platform electrically connected to the driver-side device. The management platform generates vehicle dynamic records and passengers' historical records of the taxi. Fast and convenient taxi management techniques are thus provided through real-time information and statistics, and the passenger efficiency of the taxi and the service quality are improved.

### BACKGROUND OF THE INVENTION

1. Field of the Invention

This invention relates to vehicle management techniques, and, more particularly, to a taxi management apparatus and a taxi management system.

2. Description of Related Art

With the rapid development of the mass transportation system, taxis are seldom occupied by passengers. A taxi can pick up passengers randomly. However, a taxi running in this way is not only helpless in increasing the number of passengers that the taxi can pick up every day, but also consumes more gas. On the contrary, if the taxi stays at a taxi stop all the time, passengers cannot hail a taxi immediately at any place where they are.

To address the problem, a taxi dispatching system is brought to the market. A taxi driver can join the taxi dispatching system and pays some monthly fees to the owner of the taxi dispatching system, and the owner dispatches his taxi when passengers call the taxi dispatching system. However, the taxi does not run all day, and the taxi dispatching system cannot understand the actual working hours and actual income of the taxi driver and the time when the taxi is occupied, an cannot know whether a taxi is available to pick up passengers.

The taxi dispatching system cooperates with servers, communication networks and a satellite positioning system to match a taxi and passengers. However, the taxi dispatching system selects a taxi only based on a geographic location where the passenger stays, without further considering the basic data of the driver and the passengers, specific requirements of the passengers, a predetermined running route, estimated fare, and estimated time when the taxi can arrive at the destination after the passenger call the taxi dispatching system and the dispatched taxi arrives at the origin where the passenger stays. As a result, the passenger leaves the assigned origin before the dispatched taxi arrives at the origin, the driver refuses picking up the passenger when the taxi arrives at the origin, or the driver makes a detour and overcharges the passenger.

However to solve the above-mentioned problems is becoming one of the most important issues in the art.

### SUMMARY OF THE INVENTION

In order to solve the problems of the prior art, the present invention provides a taxi management apparatus, comprising: a taximeter stored with a charging program, installed in a taxi, and generating real-time positioning data, a start-charging signal, a stop-charging signal and charging data of the taxi; and a driver-side device stored with a map program, electrically connected to the taximeter, receiving the real-time positioning data and generating dynamic data of a geographic region where the taxi is located, generating carrying origin and time corresponding to the real-time positioning data every time the taximeter transmits the start-charging signal, and compiling the carrying origin and time on the driver-side device to generate passenger information, wherein when the taxi has no passenger stayed therein, the driver-side device compares the dynamic data with the carrying origin in the passenger information to display the passenger information in a geographic region where the taxi is located.

The present invention further provides a taxi management system, comprising: a plurality of the taxi management apparatuses, each of the driver-side devices transmitting the real-time positioning data, the start-charging signal, the stop-charging signal, the charging data and the passenger information; and a management platform electrically connected to the driver-side devices, receiving the real-time positioning data and generating vehicle dynamic records of a plurality of taxis installed with the taxi management apparatuses, and receiving the charging data and the passenger information to generate passengers' historical records, wherein when the driver-side device transmits an inquiry message to the management platform, the management platform returns to the driver-side device the vehicle dynamic records and the passengers' historical records of the geographic region where the taxi is located.

In an embodiment, the management platform includes: a matching module that receives a passenger condition transmitted from the driver-side device and a service requirement transmitted from a client-end device, transmits a fare quotation to the client-end device based on the service requirement, receives a dispatch requirement transmitted from the client-end device, and compares the dispatch requirement with the passenger condition and the vehicle dynamic record to generate a matching list; a dispatching module that transmits the matching list to the client-end device, receives a taxi that is selected by the client-end device from the matching list, and transmits a dispatch instruction to the driver-side device of the selected taxi; and a notifying module that receives the real-time positioning data of the selected taxi to generate estimated arriving time of the selected taxi, and keeps on transmitting the estimated arriving time or the dynamic data of the selected taxi to the client-end device before the selected taxi arrives at an origin of the service requirement.

In an embodiment, the taxi management apparatus records an in-service process of the taxi according to the real-time positioning data of the taxi, and compiles the running process into passenger information. In another embodiment, the taxi management system further integrates the real-time positioning data and the passenger information of the taxis and compiles the vehicle dynamic records and passengers' historical records of the taxis, thereby providing real-time, transparent and complete data to the drivers and passengers for the references of a randomly picking up and dispatching services.

### BRIEF DESCRIPTION OF DRAWINGS

The invention can be more fully understood by reading the following detailed description of the preferred embodiments, with reference made to the accompanying drawings, wherein:

FIG. 1 is a functional block diagram of a taxi management apparatus according to the present invention;

FIG. 2 is a flow chart illustrating the operation of a taximeter of a taxi management apparatus according to the present invention;

FIG. 3 is a flow chart illustrating the operation of a driver-side device of a taxi management apparatus according to the present invention;

FIG. 4 is a picture displayed on a driver-side device of a taxi management apparatus according to the present invention in which a taxi is not occupied;

FIG. 5 is a picture displayed on a driver-side device of a taxi management apparatus according to the present invention in which a taxi is occupied;

FIG. 6 is a functional block diagram of a taxi management system according to the present invention;

FIG. 7 is a functional block diagram of a management platform of a taxi management system according to the present invention;

FIG. 8 is a flow chart illustrating a matching stage in a taxi dispatching service according to the present invention; and

FIG. 9 is a flow chart illustrating dispatching and notifying stages in a taxi dispatching service according to the present invention.

### DETAILED DESCRIPTION OF THE INVENTION

The following illustrative embodiments are provided to illustrate the disclosure of the present invention, these and other advantages and effects can be apparently understood by those in the art after reading the disclosure of this specification. The present invention can also be performed or applied by other different embodiments. The details of the specification may be on the basis of different points and applications, and numerous modifications and variations can be devised without departing from the spirit of the present invention.

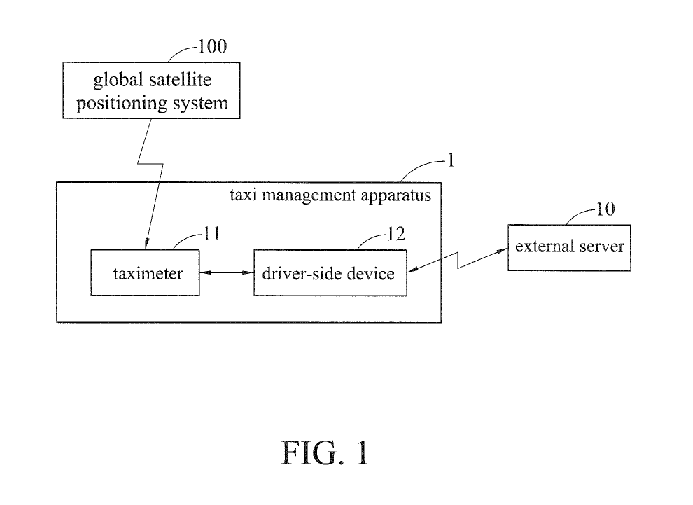

FIG. 1 is a function block diagram of a taxi management apparatus 1 according to the present invention. The taxi management apparatus 1 comprises a taximeter 11 that can be installed in a taxi and a driver-side device 12 that is electrically connected to the taximeter 11.

The taximeter 11 has a variety of functions, such as speed counting, time counting, distance counting, fare counting, displaying, receiving, transmitting and printing. The taximeter 11 receives a positioning signal of a global satellite positioning system 100 to generate real-time positioning data of the taxi. The real-time positioning data generated by the taximeter 11 can be transmitted in wired or wireless manner to the driver-side device 12. The driver-side device 12 can be a mobile communication device (e.g., a smart phone or a tablet computer) that can be electrically connected to an external server 10 to receive, transmit and store various information.

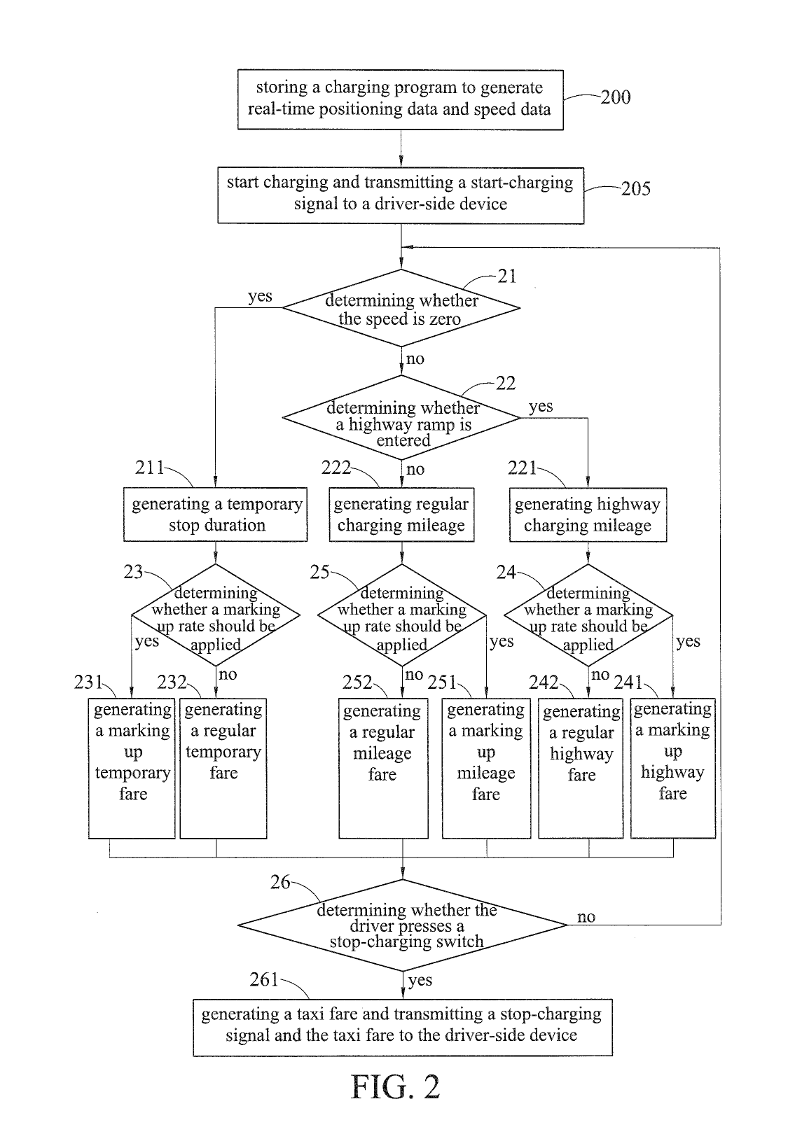

FIG. 2 is a flow chart illustrating the operation of the taximeter 11 of the taxi management apparatus 1 according to the present invention. In step 200, the taximeter 11 is stored with a charging program that includes, but is not limited to, at least one of a regular charging rate, a marking up rate, highway ramp geographic data and a highway fare rate. The taximeter 11, after receiving the rotation speed data of the wheels of the taxi, can generate a driving speed of the taxi according to a predetermined radius of the wheels.

In step 205, when the driver presses a charging switch, the taximeter 11 generates and transmits a start-charging signal to the driver-side device 12, and step 21 is proceeded. In step 21, whether the speed data of the taxi is zero is determined. If the speed data of the taxi is not zero, step 22 is proceeded, or step 211 is proceeded, in which a temporary stop duration is generated.

After step 211 is completed, step 23 is proceeded, in which whether the marking up rate should be applied is determined according to the real time. If the marking up rate should be applied, step 231 is proceeded, in which a marking up temporary fare is generated according to the temporary stop duration and the marking up rate, or step 232 is proceeded, in which a regular temporary fare is generated according to the temporary stop duration and the regular charging rate. After step 231 or step 232 is complete, step 26 is proceeded.

When the taximeter 11 determines that the speed of the taxi is not zero, step 22 is proceeded, in which the real-time positioning data and the highway ramp geographic data are compared to determine whether a highway ramp is entered. If the highway ramp is entered, step 221 is proceeded, in which highway charging mileage is generated, or step 222 is proceeded.

After step 211 is complete, step 24 is proceeded, in which whether the marking up rate is applied is determined according to the real time. If the marking up rate is applied, step 241 is proceeded, in which a marking up highway fare is generated according to the highway fare rate, the charging mileage and the marking up rate, or step 242 is proceeded, in which a regular highway fare is generated according to the highway fare rate, the charging mileage and the regular charging rate. After step 241 or step 242 is complete, step 26 is proceeded.

If the taximeter 11 determines that the taxi does not enter a highway ramp, step 222 is proceeded, in which regular charging mileage is generated. After step 222 is complete, step 25 is proceeded, in which whether the marking up rate is applied is determined. If the marking up rate is applied, step 251 is proceeded, in which a marking up mileage fare is generated according to the charging mileage and the marking up rate, or step 252 is proceeded, a regular mileage fare is generated according to the charging mileage and the regular charging rate. After step 251 or step 252 is complete, step 26 is proceeded.

After the taximeter 11 completes step 231, step 232, step 241, step 242, step 251 or step 252, step 26 is proceeded, in which whether the driver presses a stop-charging switch is determined. If the driver presses the stop-charging switch, step 21 is proceeded, in which a next fare counting process is performed, or step 261 is proceeded, in which a taxi fare is generated and the stop-charging signal and the taxi fare are transmitted to the driver-side device 12.

At least one of the driving speed, the temporary stop duration, the highway charging mileage, the charging mileage and the taxi fare can be called the charging data generated by the taximeter 11.

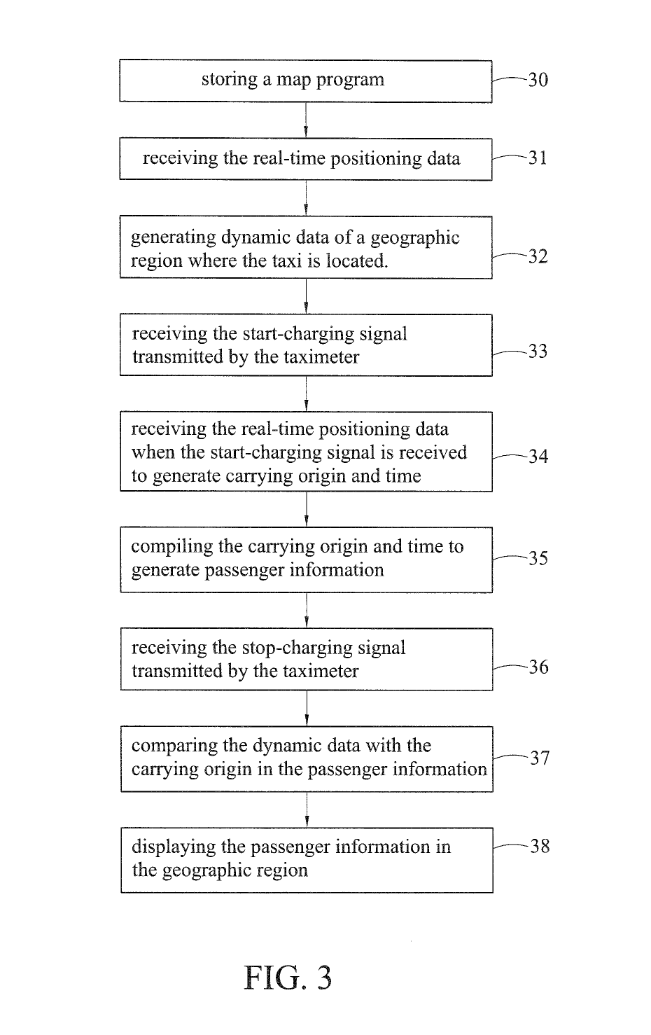

FIG. 3 is a flow chart illustrating the operation of the driver-side device 12 of the taxi management apparatus 1 according to the present invention. In step 30, the driver-side device 12 is stored with a map program. After the driver-side device 12 completes step 31 and receives the real-time positioning data transmitted by the taximeter 11, step 32 is proceeded, in which the real-time positioning data and geographic coordinates in the map program are compared to generate dynamic data of a geographic region where the taxi is located.

For example, when a driver drives a taxi on a road, the driver-side device 12 can display dynamic data, including geographic regions (e.g., an A region), road names (e.g., roads R1-RN), the speed of the taxi (e.g., X km/hour), running directions (e.g., displayed by a compass) and running routes. In an embodiment, the driver can select and set the size of the geographic region (A region).

When the taximeter 11 transmits the start-charging signal to the driver-side device 12, the driver-side device 12 completes step 33. After the driver-side device 12 receives the start-charging signal transmitted by the taximeter 11, step 34 is proceeded, in which the real-time positioning data are received when the start-charging signal is received to generate carrying origin and time. After step 34 is complete, step 35 is proceeded, in which the carrying origin and time are compiled on the driver-side device 12 to generate passenger information.

In the taxi management apparatus 1, when the taxi runs to the neighborhood of no. N1, road R1 at H1:M1, and the driver-side device 12 receives the start-charging signal transmitted by the taximeter 11, the driver-side device 12 generates occupied record data (occupied time: H1:M1, occupied location: No. N1, road R1). The driver-side device 12 compiles the occupied record data to be the passenger information. The passenger information can be a folder-type file that stores the occupied record data of the taxi. The passenger information can be compiled according to the timing sequence of the occupied time (yy/mm/dd H1:M1) in the occupied record data or the carrying origin (No. N1, road R1).

When the taxi is occupied, the driver-side device 12 can display the carrying route according to the dynamic data. When the taximeter 11 transmits the stop-charging signal and the taxi fare to the driver-side device 12, the driver-side device 12 enters step 36 and receives the stop-charging signal and the taxi fare transmitted by the taximeter 11. When the taxi is not occupied, the driver-side device 12 enters step 37 and compares the dynamic data with the carrying origin in the passenger information. After occupied record data that are matched are selected, step 38 is proceeded, in which the passenger information in a geographic region where the taxi is located is displayed.

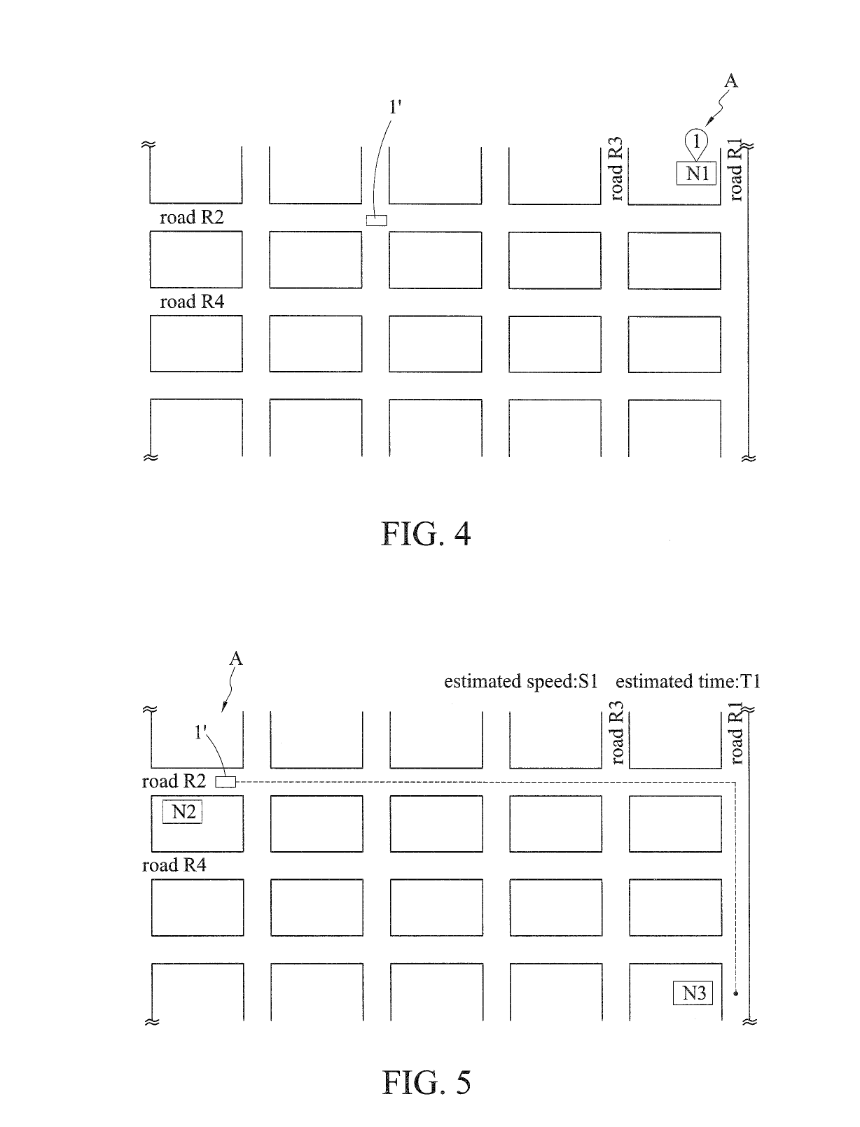

In the taxi management apparatus 1, as shown in FIG. 4 when a taxi 1′ is not occupied and runs on a road R2 in the A region, the driver-side device 12 compares a geographic coordinate of the carrying origin in the passenger information. If the carrying origin (occupied time: H1:M1, occupied location: No. N1, road R1) falls within the geographic coordinate range (roads R1-RN) in the A region, the driver-side device 12 displays the number of time when the taxi is occupied at No. N1, road R1 in the A region, for the driver to take as reference information for randomly picking up passengers.

When the taxi is occupied, the driver-side device 12 according to the present invention can display the dynamic data and compile the passenger information in a manner different from the above-described carrying route or occupied location and time.

In the taxi management apparatus 1, the driver-side device 12 can receive traffic information and destination data of a passenger transmitted from an external server to generate the dynamic data, and the dynamic data include at least one of a running route, estimated driving speed and estimated time when the destination is arrived of the taxi, for the driver and passenger to refer to the running route.

In the taxi management apparatus 1, as shown in FIG. 5 when the taxi 1′ inputs through voices or receives from a dispatching system destination location (e.g., No. N3, road R1) of a passenger and is on the way to the destination location, the driver-side device 12 displays a predetermined running route of the taxi (dashed lines shown in FIG. 5, running straight from road R2 and turning right to road R1), estimated speed S1, and estimated time T1.

In the taxi management apparatus 1 according to the present invention, the driver-side device 12 further selects the carrying origin and time in the passenger information based on the set duration to display the passenger information within a geographic region where the taxi is located that matches the set duration.

In the taxi management apparatus 1, geographic regions within which more passengers appear are different at different time segments. The driver may input a set duration (e.g., a half hour) to the driver-side device 12. When the taxi that is not occupied runs within the A region, the driver-side device 12 compares the R region where the taxi is located (roads R1-RN) with the carrying origins in the passenger information where a couple of times that the occupied record data are accumulated, to select the occupied record data that match with the geographic region conditions (e.g., road R1/H1 and road R2/H2 after two occupied record data are compared to be matched with the geographic region conditions). The occupied time (e.g., H1 and H2) in the occupied record data that are matched with the geographic region conditions are then selected according to the real time when the taxi is running within the A region (e.g., H1) plus/minus the set duration (H1±0.5=H0.5-H1.5), and the driver-side device 12 will display the passenger information within the A region that is matched with the H0.5-H1.5 set duration condition (H1) (as shown in FIG. 4, the number of time that the taxi is occupied on No. N1, road R1 is equal to one), for the driver to take as reference information for randomly picking up passengers.

In the taxi management apparatus 1 according to the present invention, the driver-side device 12 further corresponds to the real-time positioning data when the taximeter 1 transmits the stop-charging signal to generate the carrying time, the carrying route and the carrying destination and time, so as to compile on the driver-side device 12 the carrying time, the carrying route and the carrying destination and time and add the carrying time, the carrying route and the carrying destination and time to the passenger information. In addition to the carrying origin and time, the carrying route and the carrying destination and time, the driver-side device 12 can further compile the charging data generated by the taximeter 11 and add the charging data into the passenger information.

In the taxi management apparatus 1 according to the present invention, the occupied record data in the passenger information include carrying origin and time, the carrying route and the carrying destination and time, such as occupied time: H2:M2, occupied origin: No. N2, road R2, occupied route: roads R2-R1, occupied destination: No. N3, road R1, arrival time: H3:M3, and taxi fare D. When the taxi is not occupied, the driver-side device 12 can display the number of times that the taxi is occupied within a geographic region where the taxi is located (as shown in FIG. 4, one is labeled at No. N1, road R1 in the A region). If the driver needs the details in the passenger information about the occupied record data, such as the occupied route, occupied destination location and time, and taxi fare, he may click the number of times that the taxi is occupied displayed on a screen, and the screen will display details that indicate the occupied record data. If the taxi is within the A region, and the driver wants to search the passenger information within a B region, he may move the geographic region displayed by the driver-side device 12 to the B region and then check the passenger information within the B region, for the driver to take as reference information for randomly picking up passengers.

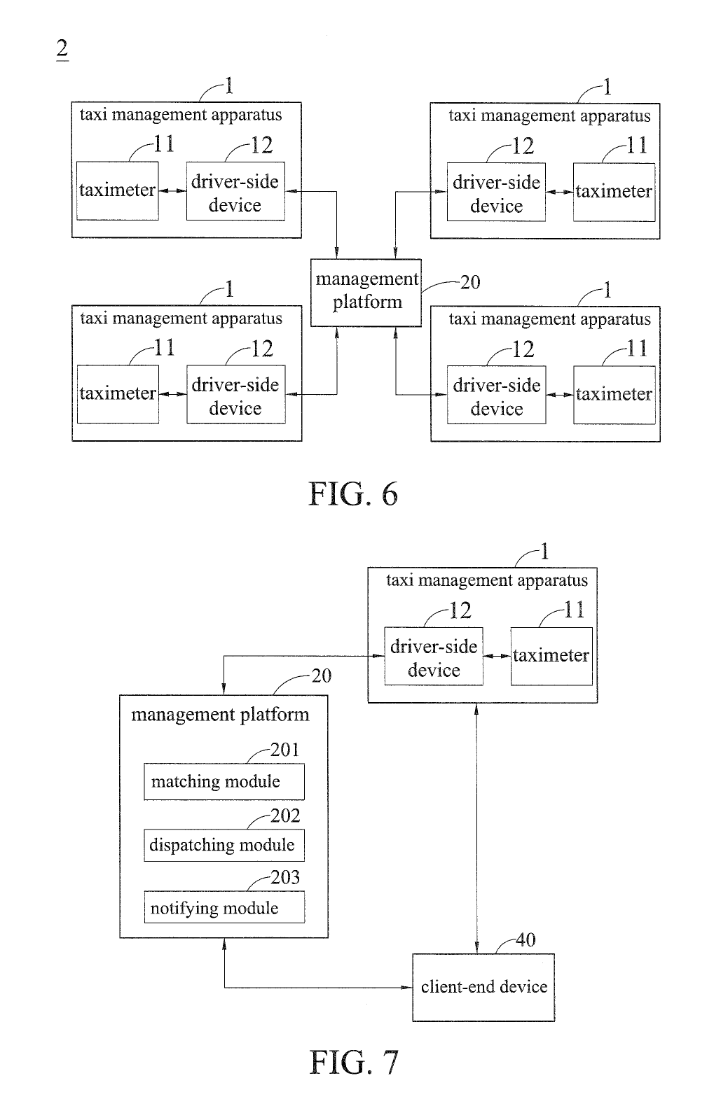

FIG. 6 is a functional block diagram of a taxi management system 2 according to the present invention. The taxi management system 2 comprises a plurality of the taxi management apparatuses 1 and a management platform 20. Each of the driver-side devices 12 transmits the real-time positioning data, the start-charging signal, the stop-charging signal, the charging data and the passenger information. The management platform 20 is electrically connected to the driver-side devices 12 and receives the real-time positioning data to generate vehicle dynamic record of a plurality of taxis having the taxi management apparatuses 1 installed therein. The management platform 20 also receives the charging data and the passenger information to generate passengers' historical records. When the driver-side devices 12 transmit an inquiry message to the management platform 20, the management platform 20 returns to the driver-side device 12 vehicle dynamic record of the geographic region where the taxis are located and the passengers' historical records.

The management platform 20 digitally integrates taxi fare charging data, back-end management software, map software, taxi management software, dispatching service software, operation software, and cloud database with a server having an operation platform, and allows drivers and passengers to download application software of the driver-side devices 12 and client-end devices 40. Each of the taximeters 11 has identification codes embedded therein. Each of the driver-side devices 12 has dedicated communication codes. The real-time positioning data and the passenger information transmitted by driver-side devices 12 include the dedicated communication codes of the driver-side device 12 and the identification codes of the taximeters 11. The management platform 20 can thus identify the taxis according to the dedicated communication codes and the identification codes, and track the dynamic data of the taxis to generate the vehicle dynamic records of the taxis.

For example, after receiving the real-time positioning data, the start-charging signal, the stop-charging signal, the charging data and the passenger information transmitted by the driver-side devices 12 within the A region, the management platform 20 compiles the real-time positioning data of the taxis to generate the vehicle dynamic records of the taxis within the A region (e.g., the number of taxis on road R1, the number of taxis on road R2, . . . the number of taxis on road RN); and the management platform 20 compiles the passenger information of the driver-side devices 12 within the A region to generate the passengers' historical records (e.g., the number of time that the taxis are occupied on road R1, the number of time that the taxis are occupied on road R2, . . . the number of time that the taxis are occupied on road RN). When the driver uses the driver-side device 12 to transmit an inquiry message to the management platform 20, the management platform 20 returns the vehicle dynamic records (the number of taxis on road R1, the number of taxis on road R2, . . . the number of taxis on road RN) and the passengers' historical records (the number of times that the taxis are occupied on road R1, the number of times that the taxis are occupied on road R2, . . . the number of times that the taxis are occupied on road RN) of the taxis within the A region according to the real-time positioning data of the taxis, for the driver who provides the inquiry to take them as reference information for randomly picking up passengers.

Besides, the management platform 20 or the driver-side devices 12 can set or change a range of a geographic region where the taxis are located that is returned by the management platform 20, e.g., a geographic region that is centered in the real-time positioning data of the taxi and has a radius equal to a distance that the taxi drives for one hour. The driver can also use the driver-side devices 12 to select a geographic location, and transmit the inquiry messages of the selected geographic location to the management platform 20, and the management platform 20 returns the vehicle dynamic records and the passengers' historical records of a geographic region containing the selected geographic location.

In the taxi management system 2 according to the present invention, the management platform 20 further receives traffic information of an external device and destination data of a passenger to generate the vehicle dynamic records, and the vehicle dynamic records include at least one of a running route, a driving speed and estimated time when the destination is arrived of the taxis. The management platform 20 generates the carrying time, the carrying route and the carrying destination and time in the passenger information by corresponding to the dynamic data every time the driver-side devices 12 transmit the start-charging signal and the stop-charging signal, and compiles and adds the passenger information to the passengers' historical records.

In the taxi management system 2 according to the present invention, when providing dispatching services, the management platform 20 receives destination data of a passenger input to the driver-side device 12, and generates a running route, a driving speed and estimated time when the destination is arrived of a taxi that is occupied by the passenger according to the destination data of the passenger, the real-time positioning data of the taxi, and real-time traffic information provided by an external server, to protect the passenger when he stays in the taxi.

In the taxi management system 2 according to the present invention, the management platform 20 can classify the vehicle dynamic records of the taxis within the A region into occupied taxis and unoccupied taxis according to the start-charging signals and the stop-charging signals of the driver-side devices 12. The management platform 20 can further compile and add the carrying origin and time, occupied time, occupied routes and occupied destination and time of the taxis to the passengers' historical records.

In the taxi management system 2 according to the present invention, after receiving the passengers' historical records, the driver-side devices 12 can display only the A region where the taxi is located (e.g., the number of times that the taxi is occupied on road R1, the number of times that the taxi is occupied on road R2, . . . the number of times that the taxi is occupied on road RN). The driver, if needing the details of the carrying record data in the passengers' historical records, may click the number of times that the taxi is occupied displayed on a screen. The passengers' historical records can be compiled into a variety of types of files, including words, tables, figures and images. The driver can also search the passengers' historical records according to geographic regions, time segments or other conditions.

A taxi management system according to the present invention can thus not only provide real-time vehicle dynamic records and complete passengers' historical records to the driver-side devices 12, but also provide safe and convenient taxi dispatching services.

FIG. 7 is a functional block diagram of a management platform 20 of a taxi management system according to the present invention. The management platform 20 comprises a matching module 201, a dispatching module 202 and a notifying module 203. The management platform 20 is connected via a network to the driver-side devices 12 and the client-end devices 40, to provide taxi dispatching services. The driver-side devices 12 are stored with the application software (APP) of the taxi management system according to the present invention, and receive the vehicle dynamic records, carrying history and dispatching services provided by the management platform 20. A driver is allowed to set his personal passenger conditions, including time segments and regions that the taxi can be dispatched, the lowest fare, the number of passengers, the number of luggage and the destination of the passenger that the taxi picks up randomly, by using the APP of the driver-side device 12 to connect the management platform 20. The management platform 20 can thus match and dispatch accordingly. The driver can also login the management platform 20 via the driver-side device 12 and transmit and change his personal passenger conditions. The management platform 20 provides a taxi dispatching service that includes a matching stage, a dispatching and notifying stage, a carrying (occupied) stage and a subsequent service stage.

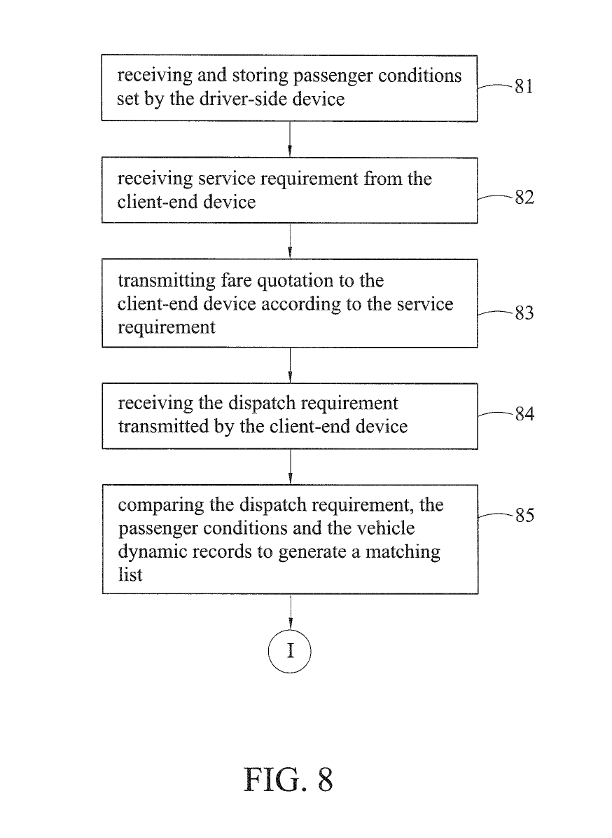

FIG. 8 is a flow chart illustrating the matching stage in a taxi dispatching service according to the present invention. In step 81, passenger conditions are received and stored in the driver-side device 12. In step 82, the matching module 201 receives service requirement from the client-end device 40. In step 83, fare quotation is transmitted to the client-end device 40 according to the service requirement. In step 84, dispatch requirement transmitted by the client-end device 40 is received. In step 85, the dispatch requirement, the passenger conditions and the vehicle dynamic records are compared to generate a matching list. Then, the taxi dispatching service enters the dispatching and notifying stage.

In the dispatching services of the taxi management system according to the present invention, the fare quotation includes a suggested route and estimated fare, and the matching list includes taxis, occupied or unoccupied, that will not be occupied for a certain period.

For example, the service requirement transmitted by the client-end device 40 includes origin (No. N2, road R2), destination (No. N3, road R1) and required time (H2:M2), and the fare quotation transmitted by the matching module 201 includes a suggested route (running straight from road R2 and then turning right to road R1) and estimated fare (D1 dollars). The matching module 201 determines whether some taxis can arrive at the origin (No. N2, road R2) before the required time (H2:M2) based on the dynamic data of the taxis, occupied and unoccupied, in the vehicle dynamic records and the destination of the passengers that occupy the taxis and generate the matching list. The destination of the passengers is input to the matching module 201 when the client-end device 40 in the dispatching service transmits the service requirement or when the driver-side device 12 transmits the passenger conditions when the passenger is picked up randomly. The matching module 201 generates the matching list according to the vehicle dynamic records, thus avoiding the problem that some drivers cannot arrive at the origin (No. N2, road R2) assigned by the passenger before the required time (H2:M2), but still strive for the dispatching opportunity, and ends up with a late dispatching.

With regard to specific time segments or specific regions (e.g., rush hours in business regions, nighttime or holiday in recreation regions), the matching module 201 further arranges the order of taxis that can be dispatched, transmits the dispatch requirements subsequently to the driver-side devices 12 of the taxis that can be dispatched according to the traffic information provided by an external server, and generates the matching list according to the reply messages that agree with the dispatch requirements, in order for providing taxi dispatching services on time.

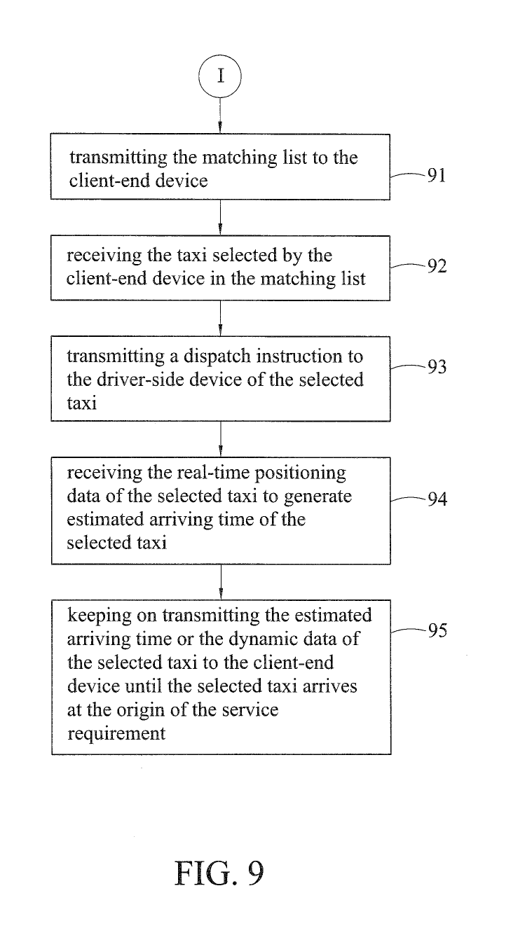

FIG. 9 is a flow chart illustrating the dispatching and notifying stages in a taxi dispatching service according to the present invention. After the matching module 201 completes step 85, the dispatching module 202 enters step 91, and transmits the matching list to the client-end device 40. In step 92, the taxi selected by the client-end device 40 in the matching list is received. In step 93, a dispatch instruction is transmitted to the driver-side device 12 of the selected taxi. After the dispatching module 202 completes step 93, the notifying module 203 enters step 94, and receives the real-time positioning data of the selected taxi to generate estimated arriving time of the selected taxi. The notifying module 203, before the selected taxi arrives at the origin of the service requirement, keeps on executing step 95, and transmits the estimated arriving time or the dynamic data of the selected taxi to the client-end device 40. After the notifying module 203 completes step 95, the taxi dispatching service enters the carrying (occupied) stage.

In the carrying (occupied) stage of the taxi dispatching service according to the present invention, when the selected taxi is occupied by the passenger, the driver presses a charging switch of the taximeter 11 of the selected taxi, and the driver-side device 12, after the taximeter 11 transmits the start-charging signal to the driver-side device 12, generates and displays a predetermined running route, estimated time when a destination is arrived, and estimated taxi fare according to the destination of the dispatch requirement. The selected taxi may have a multi-media output device (e.g., audio/video devices, not shown) that is electrically connected to the driver-side device 12. The multi-media output device outputs the predetermined running route, the estimated location and time when the taxi arrives at the destination, and the estimated taxi fare simultaneously, for the passenger to view or listen them while staying in the taxi. The driver-side device 12 can also display real-time information, such as an actual running route, actual location and time when the taxi arrives at the destination, and actual taxi fare, and transmit them simultaneously to the multi-media output device, for comparison by the passenger while staying in the taxi. When the driver-side device 12 of the selected taxi transmits the start-charging signal to the management platform 12, the management platform 12 counts the running mileage, the carrying time and the taxi fare of the passenger.

With regard to the subsequent services of the taxi dispatching service according to the present invention, after the driver-side device 12 of the selected taxi transmits the stop-charging signal to the management platform 20, the notifying module 203 notifies the client-end device 40 of the running mileage, the carrying time, the taxi fare and the opinion survey. The management platform 20 generates accumulative mileage, accumulative running time and accumulative fare of the passenger according to the running mileage, the carrying time and the taxi fare of the passenger, and defines a member class of the passenger, which is a basis for the management platform 20 to provide grace carrying mileage, bonus points, advertisement or fare deduction to the passenger. The management platform 20 generates driver evaluation of the selected taxi according to the opinion survey returned by the client-end device 40, and the matching module 201 generates the matching list according to the driver evaluation of the selected taxi, to verify the performance of the driver and improve service quality.

The taxi management system 2 according to the present invention can be applied to any current charging mechanisms, such as credit cards, pre-paid cards or member cards that allow members to deposit some money therein, pay the taxi fare by the credit cards, or pay the taxi fare periodically. The management platform 20 transmits via e-mails occupied record data and bills to the client-end device 40 of the passenger, for the passenger to check and record.

The taxi management apparatus 1 according to the present invention records the carrying process of the taxi according to the real-time positioning data of the taxi and compiles the carrying process into passenger information. The taxi management system 2 according to the present invention further integrates the real-time positioning data and the passenger information of the taxis and compiles them into vehicle dynamic records and passengers' historical records of the taxis, to provide real-time, transparent and complete data to the driver and the passengers, for the reference information for randomly picking up and dispatching services. Therefore, the taxi management apparatus and the taxi management system according to the present invention can avoid misunderstanding between the driver and the passenger, improve the service quality of the taxis, and increase the occupation rate of the taxis.

The foregoing descriptions of the detailed embodiments are only illustrated to disclose the features and functions of the present invention and not restrictive of the scope of the present invention. It should be understood to those in the art that all modifications and variations according to the spirit and principle in the disclosure of the present invention should fall within the scope of the appended claims.

What is claimed is:

1. A taxi management apparatus, comprising:
a taximeter stored with a charging program, installed in a taxi, and generating real-time positioning data, a start-charging signal, a stop-charging signal and charging data of the taxi; and
a driver-side device stored with a map program, electrically connected to the taximeter, receiving the real-time positioning data and generating dynamic data of a geographic region where the taxi is located, generating carrying origin and time corresponding to the real-time positioning data every time the taximeter transmits the start-charging signal, and compiling the carrying origin and time on the driver-side device to generate passenger information,
wherein when the taxi has no passenger stayed therein, the driver-side device compares the dynamic data with the carrying origin in the passenger information to display the passenger information in a geographic region where the taxi is located.

2. The taxi management apparatus of claim 1, wherein the charging program includes at least one of a regular charging rate, a marking up rate, highway ramp geographic data and a highway fare rate.

3. The taxi management apparatus of claim 1, wherein the charging data include at least one of a driving speed, a temporary stop duration, highway charging mileage, charging mileage and a taxi fare.

4. The taxi management apparatus of claim 1, wherein the driver-side device further receives traffic information and destination data of a passenger transmitted by an external server to generate the dynamic data.

5. The taxi management apparatus of claim 4, wherein the dynamic data include at least one of a running route, an estimated driving speed and estimated time when the taxi arrives at the destination.

6. The taxi management apparatus of claim 1, wherein the driver-side device further selects the carrying origin and time in the passenger information according to a set duration to display the passenger information in a geographic region where the taxi is located that matches with the set duration.

7. The taxi management apparatus of claim 1, wherein the driver-side device further generates the carrying time, the carrying route and the carrying destination and time by corresponding to the real-time positioning data when the taximeter transmits the stop-charging signal, and compiles on the driver-side device the carrying time, the carrying route and the carrying destination and time to add the carrying time, the carrying route and the carrying destination and time into the passenger information.

8. The taxi management apparatus of claim 7, wherein the driver-side device further compiles the charging data generated by the taximeter to add the charging data into the passenger information.

9. A taxi management system, comprising:
a plurality of the taxi management apparatuses of claim 1, each of the driver-side devices transmitting the real-time positioning data, the start-charging signal, the stop-charging signal, the charging data and the passenger information; and
a management platform electrically connected to the driver-side devices, receiving the real-time positioning data and generating vehicle dynamic records of a plurality of taxis installed with the taxi management apparatuses, and receiving the charging data and the passenger information to generate passengers' historical records,
wherein when the driver-side device transmits an inquiry message to the management platform, the management platform returns to the driver-side device the vehicle dynamic records and the passengers' historical records of the geographic region where the taxi is located.

10. The taxi management system of claim 9, wherein the management platform further receives traffic information and destination data of a passenger from an external server to generate the vehicle dynamic records, and the vehicle dynamic records include at least one of running routes, driving speeds and estimated time when the taxi arrives at the destination.

11. The taxi management system of claim 9, wherein the management platform corresponds to the dynamic data every time when the driver-side device transmits the start-charging signal and the stop-charging signal, the carrying time in the passenger information, the carrying route and the carrying destination and time, to compile the passenger information in the management platform and add the passenger information into the passengers' historical records.

12. The taxi management system of claim 9, wherein the management platform comprises:
a matching module that receives a passenger condition transmitted from the driver-side device and a service requirement transmitted from a client-end device, transmits a fare quotation to the client-end device based on the service requirement, receives a dispatch requirement transmitted from the client-end device, and compares the dispatch requirement with the passenger condition and the vehicle dynamic record to generate a matching list;
a dispatching module that transmits the matching list to the client-end device, receives a taxi that is selected by the client-end device from the matching list, and transmits a dispatch instruction to the driver-side device of the selected taxi; and
a notifying module that receives the real-time positioning data of the selected taxi to generate estimated arriving time of the selected taxi, and keeps on transmitting the estimated arriving time or the dynamic data of the selected taxi to the client-end device before the selected taxi arrives at an origin of the service requirement.

13. The taxi management system of claim 12, wherein the fare quotation includes a suggested route and an estimated fare.

14. The taxi management system of claim 12, wherein the matching list includes taxis, occupied or unoccupied, that will not be occupied for a certain period.

15. The taxi management system of claim 12, wherein the matching module arranges, according to traffic information provided by an external server, an order of taxis that can be dispatched, transmits the dispatch requirement to the driver-side devices of the taxis based on the order, and generates the matching list according to a reply message that agrees with the dispatch requirement.

16. The taxi management system of claim 12, wherein after the taximeter of the selected taxi transmits the start-charging signal, the driver-side device generates a predetermined running route, an estimated time when a destination is arrived and an estimated taxi fare according to a destination of the dispatch requirement.

17. The taxi management system of claim 16, wherein the taxi management apparatuses further include a multi-media output device that is electrically connected to the driver-side device and outputs the predetermined running route, the estimated time when the destination is arrived, and the estimated taxi fare for being viewed or listened by the passenger.

18. The taxi management system of claim 12, wherein when the driver-side device of the selected taxi transmits the start-charging signal to the management platform, the management platform calculates the running mileage, the carrying time and the taxi fare of the passenger.

19. The taxi management system of claim 18, wherein after the driver-side device of the selected taxi transmits the stop-charging signal to the management platform, the notifying module transmits the running mileage, the carrying time, the taxi fare and an opinion survey to the client-end device.

20. The taxi management system of claim 19, wherein the management platform generates accumulative mileage, accumulative running time and accumulative fare of the passenger according to the running mileage, the carrying time and the taxi fare of the passenger to define a member class of the passenger, and generates driver evaluation of the selected taxi according to the opinion survey returned by the client-end device, and the matching module generates the matching list according to the driver evaluation of the selected taxi.
